(19) United States
(12) Patent Application Publication
(10) Pub. No.: US 2013/0243595 A1
(43) Pub. Date: Sep. 19, 2013

(54) Method to rotate the rotor of a wind turbine and means to use in this method

(71) Applicants: Peter Loevenskjold Falkenberg, Herning (DK); Karl Aage MAJ, Hammel (DK); Jacob Blach NIELSEN, Engesvang (DK); Henning POULSEN, Skjern (DK); Brian RASMUSSEN, Give (DK); Henrik STIESDAL, Odense C (DK)

(72) Inventors: Peter Loevenskjold Falkenberg, Herning (DK); Karl Aage MAJ, Hammel (DK); Jacob Blach NIELSEN, Engesvang (DK); Henning POULSEN, Skjern (DK); Brian RASMUSSEN, Give (DK); Henrik STIESDAL, Odense C (DK)

(21) Appl. No.: 13/613,033

(22) Filed: Sep. 13, 2012

(30) Foreign Application Priority Data
Sep. 27, 2011 (EP) 11182933.9

(51) Int. Cl. F03D 9/00

(52) U.S. Cl. CPC F03D 9/002
USPC 416/25; 29/889.1

(57) ABSTRACT

A direct driven wind turbine includes an electrical generator with a rotor and a stator, a hub for receiving a rotor blade, and actuator device. The hub is connected to the rotor of the electrical generator, and the hub and the rotor of the electrical generator are rotatable mounted in respect to the stator of the generator. The actuator device is constructed and arranged to rotate the hub of the wind turbine in respect to the stator of the electrical generator. The actuator device is the electrical generator, wherein the electrical generator of the wind turbine is used as a motor to rotate the hub of the wind turbine.

### CROSS REFERENCE TO RELATED APPLICATIONS

This application claims priority of European Patent Office Application No. 11182933.9 EP filed Sep. 27, 2011. All of the applications are incorporated by reference herein in their entirety.

### FIELD OF INVENTION

A method to rotate the rotor of a wind turbine and means to be used in this method are provided.

### BACKGROUND OF INVENTION

A wind turbine transfers the energy of the wind into electrical energy. The wind turbine comprises a nacelle that is connected to a tower and a rotor that is connected to the nacelle. The rotor comprises a hub that is rotatable mounted to the nacelle and at least one rotor blade mounted to the hub.

The wind interacts with the rotor blade of the wind turbine in a way that the rotor rotates. The rotation of the rotor is transferred to an electrical generator.

When the wind turbine is erected, the tower is set up and the nacelle is mounted onto the tower. The hub is mounted to the nacelle and the at least one rotor blade is mounted to the hub.

The at least one rotor blade is hoisted up by a crane and connected to the hub. The hub has to be in a predetermined angular rotational position around his axis of rotation to establish the connection between the hub and the rotor blade.

This position corresponds to the direction of the blade during the fastening of the connection. The position may be a horizontal or a vertical arrangement of the hub and the rotor blade for example.

The hub has to be rotated to establish the connection between the hub and a first rotor blade. In the case of more then one rotor blade that has to be mounted, the position of the hub has to be changed. The hub has to be rotated form the first into a second position to establish the connection between the hub and the second rotor blade.

US 2006/0147308 A1 describes a method of mounting rotor blades to a rotor hub which is connected to a pod of a wind turbine power installation, including the following steps: rotating the rotor hub into a predetermined first position, fitting a rotor blade, rotation the rotor hub by means of the rotor blade into a predetermined second position, and mounting a second rotor blade, wherein the rotation of the rotor hub is effected in the direction of the effect of gravitational force of the first rotor blade which is already mounted.

This shows the disadvantage that there are no gravitational forces to support the rotation before the connection between the hub and the first rotor blade is established. Furthermore the gravitational force of a first rotor blade will support the rotation into a second position only for a part of the rotation. In a certain second part of the rotation the rotation needs to be performed against the gravitational forces of the first rotor blade. Thus the described method is not reliable enough to perform the rotation of the hub during the installation of the rotor blades.

### SUMMARY OF INVENTION

An improved method and apparatus to rotate the hub of a wind turbine during the installation of the rotor blades are provided.

A direct driven wind turbine comprises an electrical generator with a rotor and a stator, a hub constructed to receive a rotor blade, and actuator means. The hub is connected to the rotor of the electrical generator, and the hub and the rotor of the electrical generator are rotatable mounted in respect to the stator of the generator.

The actuator means are constructed and arranged to rotate the hub of the wind turbine in respect to the stator of the electrical generator. The actuator means is the electrical generator, whereby the electrical generator of the wind turbine is used as a motor to rotate the hub of the wind turbine.

In a direct driven wind turbine, the rotor of the electrical generator is either connected directly to the hub of the wind turbine or it is connected via a shaft to the hub of the wind turbine.

The rotor blades are mounted to the hub during the erection of the wind turbine. Although most of the wind turbines comprise three rotor blades, wind turbines with one or two rotor blades are known.

The hub is connected to the rotor of the electrical generator and is rotatable together with the rotor. The actuator means are constructed and arranged to rotate the rotor of the electrical generator together with the hub of the wind turbine. Thus, the hub is rotated by rotating the rotor of the electrical generator.

The electrical generator of the wind turbine is an electrical machine and shows the same type of construction as a motor. In general, a generator may also be used as a motor.

Also the electrical generator of a direct driven wind turbine may be used as a motor to rotate the rotor. Thus no additional drive is needed to rotate the hub and the rotor of the electrical generator. Also, no installation time for additional equipment is needed and time is saved during the installation or the service of the wind turbine.

A rotation of the hub is necessary for the installation of the blades, but it may also be necessary before or after the installation of the blades, for example during the installation of at least a segment of the generator, during maintenance and service, or for the dismantling of the wind turbine.

In a preferred embodiment the electrical generator comprises an electrical connection that is connected to a power source to operate the electrical generator as a motor. To operate the electrical generator of the wind turbine as a motor, the generator needs to be electrically connected to a power source. This power soured may be a battery, an emergency generator or the grid power for example.

The generator may be run as a motor by a battery or an emergency power source. Thus, the hub of the wind turbine may also be rotated when the wind turbine is not connected to the power grid. The hub may be rotated during the installation of the wind turbine, when the electrical system is not fully in operation.

When the wind turbine is already connected to the power grid, the power grid may be used as a power source. Thus, no additional power source is needed. The normal electrical connection of the generator may be used, which transports power from the generator to the power grid during normal operation. Thus, no additional electrical connection is needed.

In a preferred embodiment a controller is connected to the power source to control the operation of the electrical generator as a motor. The generator needs a special control of the power fed into the generator while the generator is used as a motor. Thus the electrical generator may be used as a motor.

For the installation of rotor blades at the hub, the hub needs to be positioned correctly. By the use of a controller the rotation of the hub may be started and stopped precisely. Thus the position of the hub may be controlled precisely.

In a preferred embodiment the controller is the controller of the wind turbine. The wind turbine comprises a controller. This controller may also be used to control the generator of the wind turbine that is used as a motor for the rotation of the hub. Thus no additional controller is needed. Thus material and installation time is saved.

In another preferred embodiment the controller is a controller separate from the turbine controller.

During the installation of the wind turbine the controller of the wind turbine might not yet be installed or the controller is not yet connected to electrical power.

The controller even might be a controller, which is designed for the generator to use as a motor. Thus the controller is optimized to control the generator. The controller may be reused in other wind turbine installation after the installation of the wind turbine blades is finished.

In a preferred embodiment the power source comprises the converter of the wind turbine.

The converter or inverter of the wind turbine is used to convert the power generated by the generator to harmonize it with the power grid. This converter may be used to convert the power of a power supply to run the generator as a motor.

The power supply may be a battery, an emergency generator or the power grid for example.

Thus no additional converter is needed to convert the power to run the generator as a motor. Thus no additional converter needs to be installed. Thus installation time is saved.

In a preferred embodiment the wind turbine comprises a brake-disc and a brake, whereby the brake is acting on the brake-disc to brake the rotation of the electrical generator. The rotational speed of the generator that is used as a motor may be reduced. Thus the rotation may be stopped. Thus the accuracy of the positioning is improved.

In a preferred embodiment the wind turbine comprises a locking system to lock the rotor of the electrical generator to fix the position of the rotor in respect to the stator.

The position of the rotor of the generator is fixed in respect to the stator of the generator. Thus the rotor of the generator may be locked to the stator. Thus unintentional rotation of the rotor is prevented.

A rotor blade is mounted to a hub of a direct driven wind turbine, by turning the hub into a predetermined position around the axis of rotation of the rotor of the electrical generator. The rotor is turned by use of the electrical generator, whereby the electrical generator of the wind turbine is used as a motor to rotate the hub of the wind turbine. A rotor blade is mounted to the hub.

The rotor blades are mounted to the hub of the wind turbine while the crane used for mounting the blades stays in one place during installation of more then one rotor blade. Time for setting up the crane at a different location is saved, which means that installation time is saved.

The figures show a preferred configuration and do not limit the scope of the invention.

### BRIEF DESCRIPTION OF THE DRAWINGS

FIG. 1 shows the installation of a rotor blade at a wind turbine.

FIG. 2 shows a cut through a hub and a generator of a direct driven wind turbine.

### DETAILED DESCRIPTION OF INVENTION

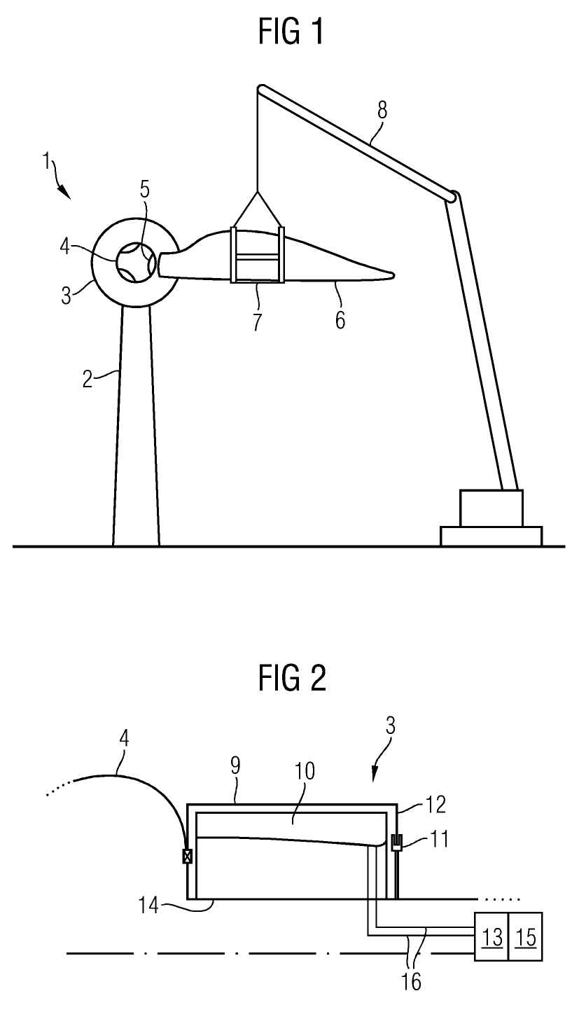

FIG. 1 shows the installation of a rotor blade at a wind turbine.

The direct driven wind turbine 1 comprises a tower 2, a generator 3 and a hub 4. The hub 4 comprises at least one location 5 to attach a rotor blade 6.

The rotor blade 6 is held by a lifting device 7 and is lifted by a crane 8. To attach the rotor blade 6 at the location 5 at the hub 4, the hub 4 is turned into a certain predetermined position.

In the example, three locations 5 for attaching a rotor blade are provided.

The crane 8 may stay in the same location to attach a second blade at a second location. To achieve this, the hub 4 is rotated by 120 degree. After the rotation of the hub 4, the location to receive the second rotor blade is in the same position where the location 5 of the first rotor blade 6 was, when the first rotor blade 6 was attached.

FIG. 2 shows a cut through a hub 4 and a generator 3 of a direct driven wind turbine. The cut is along the axis of rotation of the generator 3. The generator 3 comprises a rotor 9 and a stator 10. The stator 10 is attached to a support structure 14. A brake disc 12 is attached to the rotor 9 of the generator 3. A brake 11 is attached to the support structure 14.

The brake 11 is used for braking the rotation of the rotor 9 of the generator 3. The brake 11 comprises a locking mechanism that locks the position of the rotor 9 of the generator 3 in relation to the stator 10.

In this embodiment, the rotor 9 of the generator 3 is equipped with permanent magnets and the stator 10 of the generator is equipped with windings. During the normal operation of the wind turbine, windings of the stator are connected to an electrical system of the wind turbine and to the power grid.

The stator 10 of the generator 3 is connected to the electrical system via an electrical connection 16. This electrical system comprises a power supply 13. In this embodiment this power supply is an auxiliary power supply used during the installation of the wind turbine.

The auxiliary power supply feeds power into the stator 10 of the generator 3 to allow the use of the generator 3 as a motor. The electrical system further comprises a controller 15 that controls the power from the power supply 13.

When the hub 4 is rotated, the controller 15 feeds power from the power supply 13 into the stator 10 to accelerate the rotor 9 of the electrical machine 3.

The hub 4 is connected to the rotor 9 and rotates with the rotor 9 around the axis of rotation of the generator 3. The hub 4 is rotated into a predetermined position to attach a rotor blade for example.

A rotation of the hub may also be necessary for other purposes during the installation of the wind turbine. A rotation of the hub may also be necessary during maintenance and service.

When the predetermined position is reached, the rotation of the hub 4 is reduced by the help of the brake 11 and the brake disc 12 and the position of the rotor 9 is locked by the locking mechanism.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the term “comprising” does not exclude other elements or steps and the use of articles “a” or “an” does not exclude a plurality.

1. Direct driven wind turbine, comprising:
an electrical generator with a rotor and a stator, a hub constructed to receive a rotor blade, and actuator means,
wherein the hub is connected to the rotor of the electrical generator,
wherein the hub and the rotor of the electrical generator are rotatable mounted in respect to the stator of the generator,
wherein the actuator means are constructed and arranged to rotate the hub of the wind turbine in respect to the stator of the electrical generator,
wherein the actuator means is the electrical generator, and
wherein the electrical generator of the wind turbine is used as a motor to rotate the hub of the wind turbine.

2. Direct driven wind turbine according to claim 1, wherein the electrical generator comprises an electrical connection that is connected to a power source to operate the electrical generator as a motor.

3. Direct driven wind turbine according to claim 2, wherein a controller is connected to the power source to control the operation of the electrical generator as a motor.

4. Direct driven wind turbine according to claim 3, wherein the controller is the controller of the wind turbine.

5. Direct driven wind turbine according to claim 3, wherein the controller is a controller separate from the turbine controller.

6. Direct driven wind turbine according to claim 2, wherein the power source comprises the converter of the wind turbine.

7. Direct driven wind turbine according to claim 1, wherein the wind turbine comprises a brake-disc and a brake, wherein the brake is acting on the brake-disc to brake the rotation of the electrical generator.

8. Direct driven wind turbine according to claim 7, wherein the wind turbine comprises a locking system to lock the rotor of the electrical generator to the stator.

9. Method of mounting a rotor blade to a hub of a direct driven wind turbine, comprising the steps of:
providing a wind turbine with an electrical generator with a rotor and a stator, a hub constructed to receive a rotor blade, and actuator means,
turning the hub into a predetermined position around the axis of rotation of the rotor of the electrical generator by use of the electrical generator, wherein the electrical generator of the wind turbine is used as a motor to rotate the hub of the wind turbine, and
mounting a rotor blade to the hub.
